(19) United States
(12) Patent Application Publication
(10) Pub. No.: US 2019/0372281 A1
(43) Pub. Date: Dec. 5, 2019

(54) RECEPTACLE CONNECTOR MANUFACTURING METHOD AND RECEPTACLE CONNECTOR USING THE SAME

(71) Applicants: Hirose Korea Co., Ltd., Siheung-si (KR); Hirose Electric Co., Ltd., Tokyo (JP)

(72) Inventors: Hyeong Jun KIM, Siheung-si (KR); Ichikawa KAZUNORI, Tokyo (JP)

(21) Appl. No.: 16/425,760

(22) Filed: May 29, 2019

(30) Foreign Application Priority Data
Jun. 1, 2018 (KR) 10-2018-0063752

(51) Int. Cl. H01R 24/60; H01R 43/00

(52) U.S. Cl. CPC H01R 24/60; H01R 43/00

(57) ABSTRACT

Disclosed herein are a method of manufacturing a receptacle connector and a receptacle connector manufactured using the same. The method includes: an assembly formation step in which a first assembly is formed by superimposing a lower terminal, a middle plate, and a lower ground onto one another and integrating a lower insulation layer with exteriors of the lower terminal, middle plate, and lower ground by insert molding and a second assembly is formed by superimposing an upper terminal and an upper ground onto one another and integrating an upper insulation layer with exteriors of the upper terminal and upper ground by insert molding; and a housing formation step in which a portion of the second assembly is superimposed onto an upper side of the first assembly and a housing is insert molded to partially surround the first assembly and the second assembly such that the lower terminal, the upper terminal, and the middle plate are exposed through a front coupler of the housing and through a rear lower surface of the housing.

### CROSS-REFERENCE TO RELATED APPLICATIONS

This application claims the benefit and priority of KR Patent Application No. 10-2018-0063752, filed on Jun. 1, 2018, the entire disclosure of which is incorporated herein by reference.

### FIELD

Embodiments of the present disclosure relate to a method of manufacturing a receptacle connector and a receptacle connector manufactured using the same. More particularly, embodiments of the present disclosure relate to a method of manufacturing a receptacle connector in which a first assembly having a lower ground and a second assembly having an upper ground are insert-molded at the same time to form a housing, whereby the lower ground and the upper ground can be integrally formed with the housing by insert molding, thereby eliminating a need for press-fitting of the lower ground and the upper ground, and a receptacle connector manufactured using the same.

### BACKGROUND

Generally, a connector is composed of a plug connector and a receptacle connector, which is mounted on a printed circuit board (PCB) to be fastened to the plug connector.

Such a typical receptacle connector includes a terminal support, upper terminals arranged on an upper side of the terminal support, lower terminals arranged on a lower side of the terminal support, and an insulator surrounding the upper terminals and the lower terminals.

Here, the upper and lower terminals of the receptacle connector are arranged to meet the pin specifications of a universal serial bus (USB) and connection terminals are isolated from one another by the insulator.

However, since such a typical receptacle connector allows a plug connecter to be inserted thereinto only in one specific direction, the insertion direction of the plug connector should always be checked. In addition, during formation of an insulator of the receptacle connector, there is a concern of displacement of upper terminals and lower terminals.

As a prior art document, Japanese Unexamined Patent Publication No. 2013-303024 (Feb. 7, 2013) discloses a receptacle connector.

### SUMMARY

Embodiments of the present disclosure provide a method of manufacturing a receptacle connector in which a first assembly having a lower ground and a second assembly having an upper ground are insert-molded at the same time to form a housing, whereby the lower ground and the upper ground can be integrally formed with the housing by insert molding, thereby eliminating a need for press-fitting of the lower ground and the upper ground, and a receptacle connector manufactured using the same.

Embodiments of the present disclosure provide a method of manufacturing a receptacle connector which allows bidirectional coupling of a plug connector to the receptacle connecter, thereby enabling easy coupling of the plug connector regardless of the direction of the plug connector, and a receptacle connector manufactured using the same.

Embodiments of the present disclosure provide a method of manufacturing a receptacle connector in which a front carrier cutting portion integrally formed with a middle plate and a rear carrier cutting portion integrally formed with an upper ground are exposed in a lateral direction of a housing and are connected to a front carrier and a rear carrier, respectively, thereby allowing easy separation of the front carrier and the rear carrier from the receptacle connector during a subsequent carrier separation process, and a receptacle connector manufactured using the same.

In accordance with one aspect of the present disclosure, a method of manufacturing a receptacle connector includes: an assembly formation step in which a first assembly is formed by superimposing a lower terminal, a middle plate, and a lower ground onto one another and integrating a lower insulation layer with exteriors of the lower terminal, middle plate, and lower ground by insert molding and a second assembly is formed by superimposing an upper terminal and an upper ground onto one another and integrating an upper insulation layer with exteriors of the upper terminal and upper ground by insert molding; and a housing formation step in which the second assembly is partially superimposed onto the first assembly and a housing is insert-molded to partially surround the first assembly and the second assembly such that the lower terminal, the upper terminal, and the middle plate are exposed through a front coupler of the housing and through a rear lower surface of the housing.

In the assembly formation step, a pair of front carrier cutting portions may protrude from respective lateral ends of the middle plate and a front carrier may be connected to the pair of front carrier cutting portions, and, in the housing formation step, a pair of rear carrier cutting portions may protrude from respective lateral ends of the upper ground in a lateral direction of the housing and a rear carrier may be connected to the pair of rear carrier cutting portions.

The method may further include, after the housing formation step, a carrier cutting step in which the front carrier and the rear carrier are separated from the receptacle connecter by cutting the front carrier cutting portions and the rear carrier cutting portions.

In the housing formation step, a pair of passage holes may be formed at respective lateral ends of the housing to allow the pair of rear carrier cutting portions to protrude therethrough.

In the housing formation step, a lower insertion groove may be formed on a lower surface of the housing to correspond in position to the lower ground and an upper insertion groove may be formed on an upper surface of the housing to correspond in position to the upper ground.

In the assembly formation step, a pair of first insertion ends bent upwards from respective lateral ends of the lower ground may be formed; a pair of first insertion grooves may be formed at respective lateral ends of the middle plate to correspondingly receive the first insertion ends; a pair of second insertion ends bent downwards from respective lateral ends of the upper ground may be formed; and a pair of second insertion grooves may be formed at respective lateral ends of the middle plate to correspondingly receive the second insertion ends.

In the housing formation step, a connection end bent downwards from a rear end of the middle plate may protrude downwardly of the housing.

In accordance with another aspect of the present disclosure, a receptacle connector includes: a first assembly including a middle plate, a lower insulation layer coupled to a lower surface of the middle plate, a plurality of lower terminals passing through and coupled to the lower insulation layer in a transverse direction, and a lower ground coupled to a lower surface of the lower insulation layer to be mated with the middle plate; a second assembly including an upper insulation layer coupled to an upper surface of the middle plate, a plurality of upper terminals passing through and coupled to the middle plate in the transverse direction, and an upper ground coupled to an upper surface of the upper insulation layer to be mated with the middle plate; and a housing partially surrounding the first assembly and the second assembly and including a front coupler exposing front sections of the lower terminals, upper terminals, and middle plate therethrough and a rear lower surface exposing rear sections of the lower terminals, upper terminals, and middle plate therethrough.

The receptacle connector may further include: a pair of front carrier cutting portions protruding from respective lateral ends of the middle plate in a lateral direction of the coupler to be connected to a front carrier; and a pair of rear carrier cutting portions protruding from respective lateral ends of the upper ground in a lateral direction of the housing to be connected to a rear carrier.

The housing may have a pair of passage holes formed at respective lateral ends thereof to allow the rear carrier cutting portions to protrude therethrough.

The insulating housing may have: a lower insertion groove formed on a lower surface thereof to correspond in position to the lower ground; and an upper insertion groove formed on an upper surface thereof to correspond in position to the upper ground.

The lower ground may have a pair of first insertion ends bent upwards from respective lateral ends thereof, the upper ground may have a pair of second insertion ends bent downwards from respective lateral ends thereof, and the middle plate may have a pair of first insertion grooves receiving the respective first insertion ends and a pair of second insertion grooves receiving the respective second insertion ends, wherein the pair of first insertion grooves and the pair of second insertion grooves may be arranged at respective lateral ends of the middle plate in the transverse direction.

The upper insulation layer may have horizontal holes vertically formed at respective lateral ends thereof to allow the second insertion ends to be inserted into the second insertion grooves therethrough.

Each of the upper terminals may have a front end exposed through an upper surface of the coupler and a rear end protruding downwardly of the housing, each of the lower terminals may have a front end exposed through a lower surface of the coupler and a rear end protruding downwardly of the housing, and the middle plate may have a front end exposed in front of and at both lateral sides of the coupler.

The middle plate may have connection ends bent downwards from respective rear lateral ends thereof to protrude downwardly of the housing.

According to embodiments of the present disclosure, a first assembly having a lower ground and a second assembly having an upper ground are insert-molded at the same time to form a housing, whereby the lower ground and the upper ground can be integrally formed with the housing by insert molding, thereby eliminating a need for press-fitting of the lower ground and the upper ground.

In addition, according to embodiments of the present disclosure, the first assembly and the second assembly are insert-molded at the same time to form the housing, whereby formation of the housing can be achieved without movement of the first assembly and the second assembly, thereby securing product reliability.

Further, according to embodiments of the present disclosure, bidirectional coupling of a plug connector to a receptacle connecter is possible, thereby enabling quick coupling of the plug connector regardless of the direction of the plug connector.

Further, according to embodiments of the present disclosure, a front carrier cutting portion and a rear carrier cutting portion are exposed in a lateral direction of a housing (that is, exposed outside the housing) and then are connected to a front carrier and a rear carrier, respectively, thereby allowing easy separation of the front carrier and the rear carrier during a subsequent carrier separation process.

### DRAWINGS

FIG. 1 is a block diagram illustrating a method of manufacturing a receptacle connector according to one embodiment of the present disclosure.

FIG. 2 is a bottom perspective view of a second assembly of a receptacle connector according to one embodiment of the present disclosure.

FIG. 3 is a top perspective view of the second assembly of the receptacle connector according to the embodiment of the present disclosure.

FIG. 4 is a bottom view of the second assembly of the receptacle connector according to the embodiment of the present disclosure.

FIG. 5 is an exploded perspective view of the second assembly of the receptacle connector according to the embodiment of the present disclosure.

FIG. 6 is a perspective view of a lower insulation layer of the receptacle connector according to the embodiment of the present disclosure.

FIG. 7 is a bottom perspective view of a first assembly of the receptacle connector according to the embodiment of the present disclosure.

FIG. 8 is a top perspective view of the first assembly of the receptacle connector according to the embodiment of the present disclosure.

FIG. 9 is a bottom view of the first assembly of the receptacle connector according to the embodiment of the present disclosure.

FIG. 10 is an exploded perspective view of the first assembly of the receptacle connector according to the embodiment of the present disclosure.

FIG. 11 is a perspective view of an upper insulation layer of the receptacle connector according to the embodiment of the present disclosure.

FIG. 12 is an enlarged fragmentary perspective view showing coupling between the second assembly and the first assembly of the receptacle connector according to the embodiment of the present disclosure.

FIG. 13 is a bottom perspective view of the receptacle connector according to the embodiment of the present disclosure.

FIG. 14 is a top perspective view of the receptacle connector according to the embodiment of the present disclosure.

FIG. 15 is a perspective view of a finished product of the receptacle connector according to the embodiment of the present disclosure, with a front carrier and a rear carrier separated from the receptacle connector.

### DETAILED DESCRIPTION

Hereinafter, embodiments of the present disclosure will be described with reference to the accompanying drawings.

The above and other aspects, features, and advantages of the present disclosure will become apparent from the detailed description of the following embodiments in conjunction with the accompanying drawings.

It should be understood that the present disclosure is not limited to the following embodiments and may be embodied in different ways and that the embodiments are provided for complete disclosure and thorough understanding of the present disclosure by those skilled in the art. Therefore, the present disclosure is not limited to the following embodiments and may be embodied in different ways.

In addition, description of known functions and constructions which may unnecessarily obscure the subject matter of the present disclosure will be omitted.

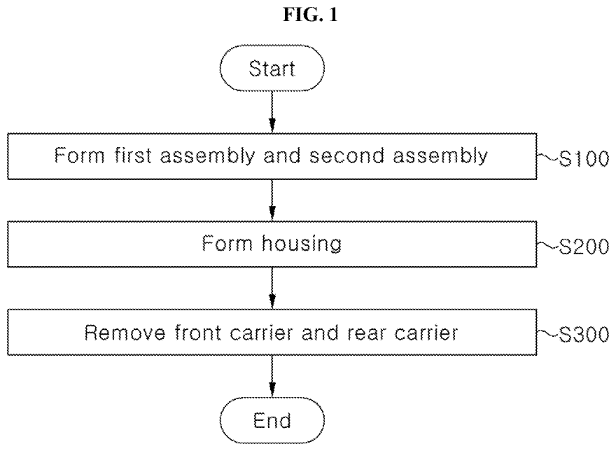

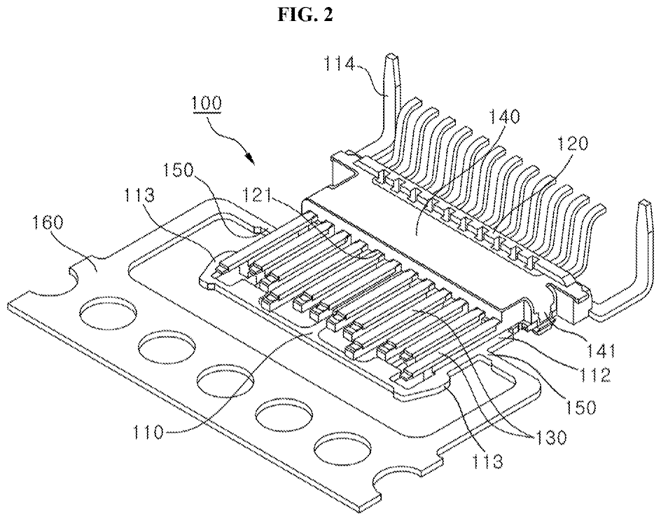

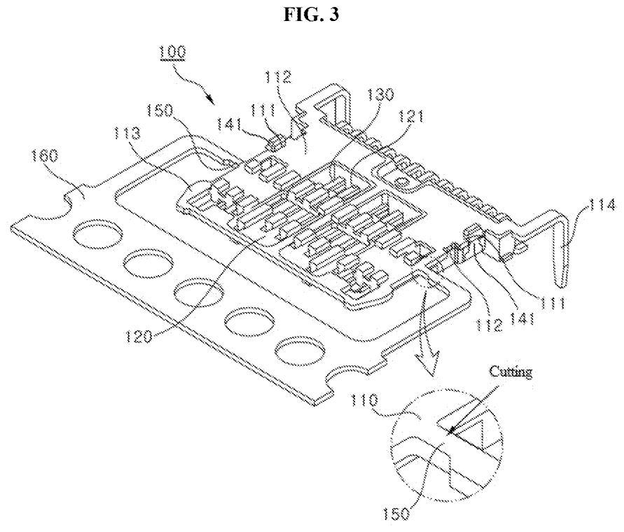

FIG. 1 is a block diagram illustrating a method of manufacturing a receptacle connector according to one embodiment of the present disclosure, FIG. 2 is a bottom perspective view of a second assembly of a receptacle connector according to one embodiment of the present disclosure, and FIG. 3 is a top perspective view of the second assembly of the receptacle connector according to the embodiment of the present disclosure.

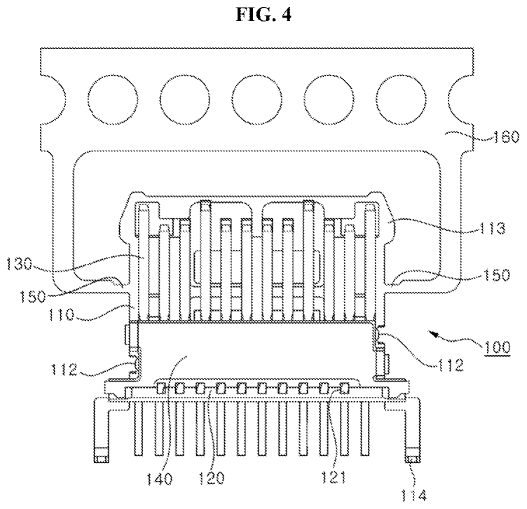

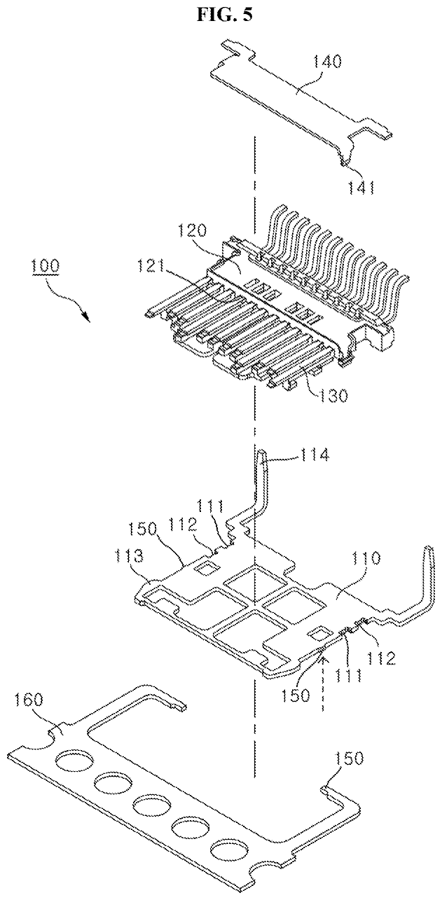

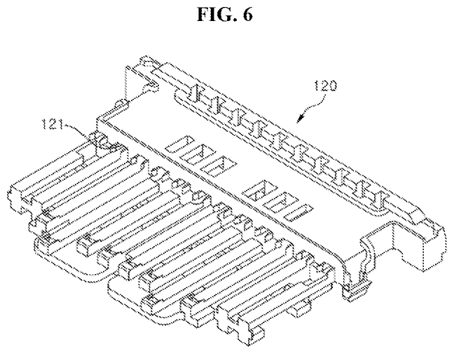

FIG. 4 is a bottom view of the second assembly of the receptacle connector according to the embodiment of the present disclosure, FIG. 5 is an exploded perspective view of the second assembly of the receptacle connector according to the embodiment of the present disclosure, and FIG. 6 is a perspective view of a lower insulation layer of the receptacle connector according to the embodiment of the present disclosure.

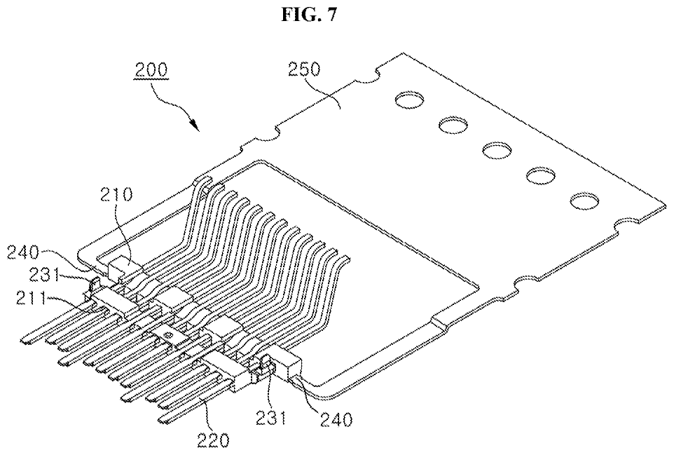

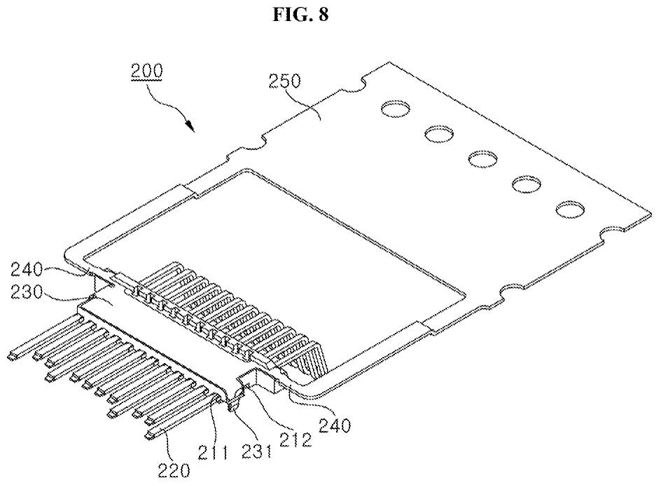

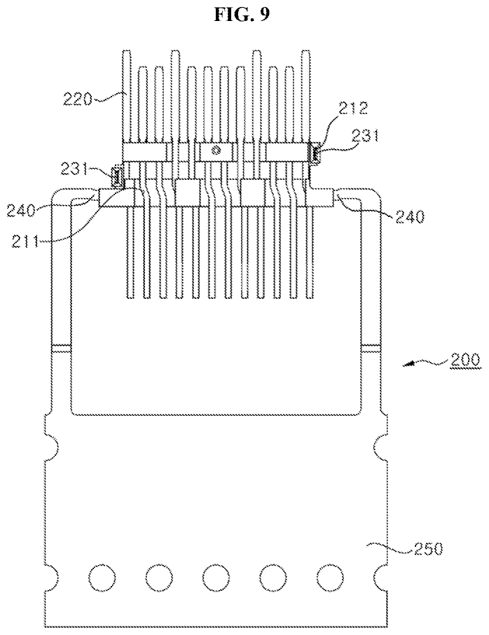

FIG. 7 is a bottom perspective view of a first assembly of the receptacle connector according to the embodiment of the present disclosure, FIG. 8 is a top perspective view of the first assembly of the receptacle connector according to the embodiment of the present disclosure, and FIG. 9 is a bottom view of the first assembly of the receptacle connector according to the embodiment of the present disclosure.

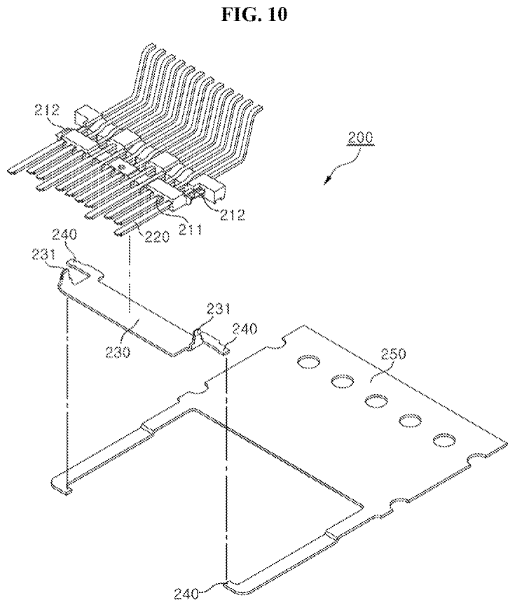

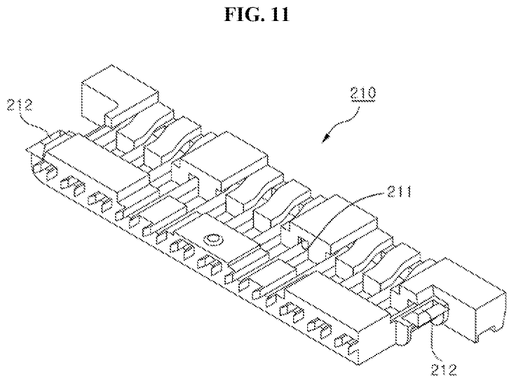

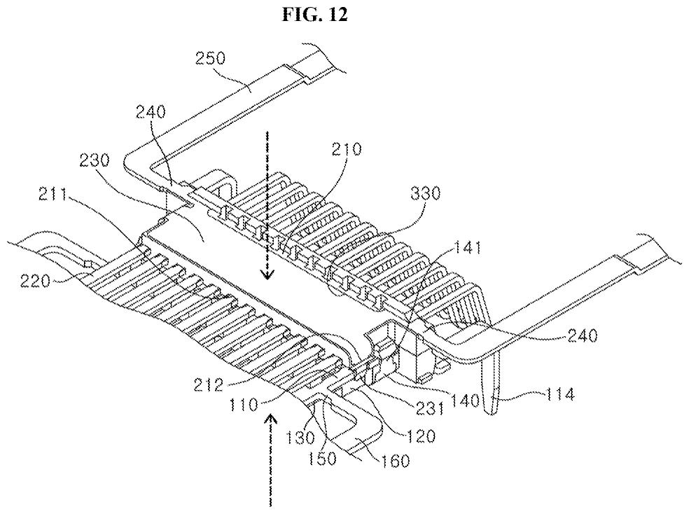

FIG. 10 is an exploded perspective view of the first assembly of the receptacle connector according to the embodiment of the present disclosure, FIG. 11 is a perspective view of an upper insulation layer of the receptacle connector according to the embodiment of the present disclosure, and FIG. 12 is an enlarged fragmentary perspective view showing coupling between the second assembly and the first assembly of the receptacle connector according to the embodiment of the present disclosure.

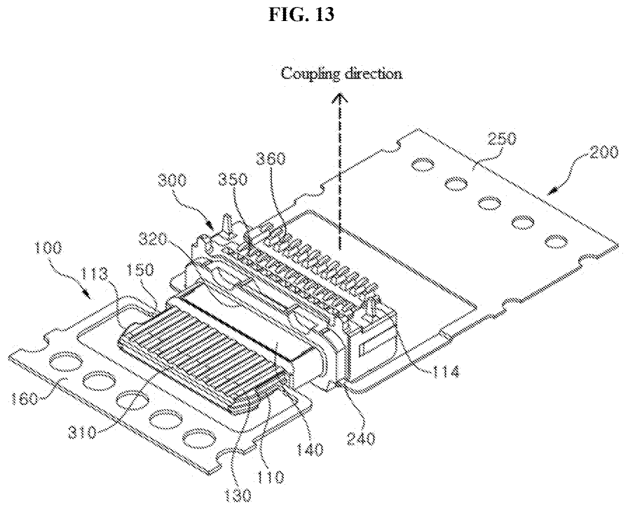

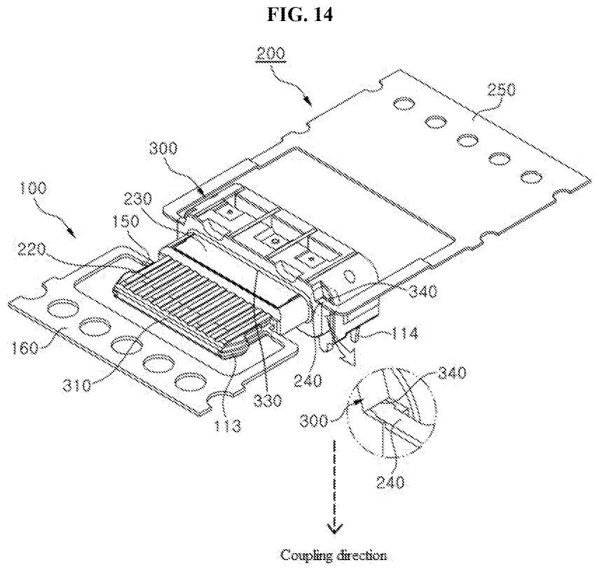

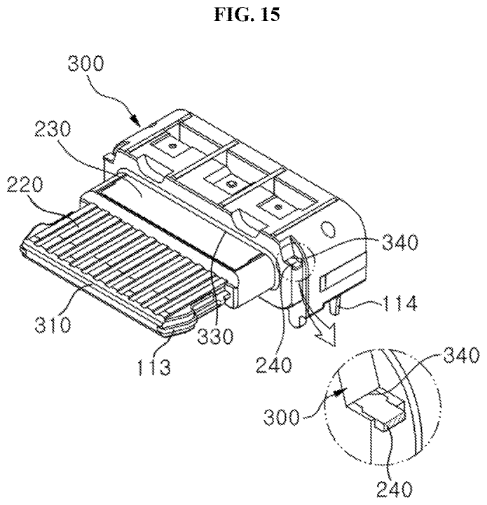

FIG. 13 is a bottom perspective view of the receptacle connector according to the embodiment of the present disclosure, FIG. 14 is a top perspective view of the receptacle connector according to the embodiment of the present disclosure, and FIG. 15 is a perspective view of a finished product of the receptacle connector according to the embodiment of the present disclosure, with a front carrier and a rear carrier separated from the receptacle connector.

Referring to FIG. 1, a method of manufacturing a receptacle connector according to one embodiment includes an assembly formation step (S100) and a housing formation step S200.

First, in the assembly formation step (S100), a first assembly 100 and second assembly 200 of a receptacle connector are formed, as shown in FIG. 2 to FIG. 4.

Here, the first assembly 100 and the second assembly 200 formed in the assembly formation step (S100) are integrally coupled to one another by insert molding in the housing formation step (S200) described below.

Specifically, the first assembly 100 includes a middle plate 110, a lower insulation layer 120, a plurality of lower terminals 130, and a lower ground 140, as shown in FIG. 2 to FIG. 5.

The first assembly 100 is formed by superimposing the lower terminals 130, the middle plate 110, and the lower ground 140 onto one another and integrating the lower insulation layer 120 with exteriors of the lower terminals 130, middle plate 110, and lower ground 140 by insert molding.

The middle plate 110 may be formed to have a predetermined area using a conductive material and is securely coupled at a rear end thereof to an upper surface of a printed circuit board (PCB) (not shown).

Here, the middle plate 110 is divided into a rear region coupled to the PCB (not shown) and a front region located inside a coupler 310 described below.

The middle plate 110 may have a pair of fastening protrusions 113 protruding from respective lateral ends of the front region and a pair of connection ends 130 bent downwards from respective lateral ends of the rear region.

Each of the connection ends 130 is inserted into and securely coupled to the upper surface of the PCB and has an extended tip which protrudes downward through a lower surface of a housing 300 and is coupled to the PCB in the housing formation step (S200) described below.

In addition, the middle plate 110 has a pair of first insertion grooves 111 formed at respective lateral ends of the rear region to correspondingly receive first insertion ends 141 described below to achieve electrical connection therebetween.

Specifically, the pair of first insertion grooves 111 correspondingly receives the first insertion ends 141 of the lower ground 140 described below and may be disposed at the respective lateral ends of the middle plate 110 to be diagonal to each other.

Further, the middle plate 110 has a pair of second insertion grooves 112 formed on respective lateral ends of the rear region to correspondingly receive second insertion ends 231 described below to achieve electrical connection therebetween.

Specifically, the pair of second insertion grooves 112 correspondingly receives the second insertion ends 231 of an upper ground 230 described below and may be disposed at the respective lateral ends of the middle plate 110 to be diagonal to each other.

The lower insulation layer 120 is formed of a nonconductive material and is integrated with a lower surface of the middle plate 110 by insert molding.

The middle plate 110 may have a plurality of vertically cut-out holes (not designated by reference numeral), whereby the lower insulation layer 120 may protrude upwards through the cut-out holes of the middle plate 110 to be caught on an upper surface of the middle plate 110.

The lower terminals 130 are coupled to the lower insulation layer 120 by insert molding and front contact surfaces of the lower terminals 130 are exposed through a lower surface of the coupler 310 described below.

Rear ends (connections) of the lower terminals 130 protrude rearwardly of the lower insulation layer 120 and then are bent downwards to be mounted on the upper surface of the PCB.

The lower ground 140 is coupled to a lower surface of the lower insulation layer 120 to be connected to the middle plate 110 and is disposed between the front and rear ends of the lower terminals 130.

Here, the lower ground 140 may be formed to have a predetermined area using a conductive material and has an upper surface securely coupled to the lower surface of the lower insulation layer 120.

To this end, the lower ground 140 has the pair of first insertion ends 141 bent upwards from respective lateral ends thereof to be mated with the respective first insertion grooves 111.

The first insertion ends 141 is correspondingly inserted into the first insertion grooves 111 and may be disposed at the respective lateral ends of the lower ground 140 to be diagonal to each other.

Particularly, the middle plate 110 has a pair of front carrier cutting portions 150 protruding from respective lateral ends thereof in a lateral direction thereof, as shown in FIG. 2 to FIG. 5.

Protruding tips of the front carrier cutting portions 150 are connected to a front carrier 160 for conveyance of the receptacle connector.

Here, the front carrier 160 is spaced in front of the first assembly 100 and may have portions extending rearwards from respective lateral ends thereof to be perpendicularly connected to the front carrier cutting portions 150.

Here, the front carrier 160 may have at least one vertical cut-out hole for conveying the receptacle connector to an assembly position using suitable equipment.

Referring to FIG. 7 to FIG. 11, the second assembly 200 may include an upper insulation layer 210, a plurality of upper terminals 220, and an upper ground 230.

The second assembly 100 may be formed by superimposing the upper terminals 220 and the upper ground 230 onto each other and integrating the upper insulation layer 210 with exteriors of the upper terminals 220 and upper ground 230 by insert molding.

The upper insulation layer 210 is formed of a non-conductive material and the lower insulation layer 120 is integrated with the upper surface of the middle plate 110 by insert molding.

The upper terminals 220 are coupled to the upper insulation layer 210 by insert molding, and front contact surfaces of the upper terminals 220 are exposed through the upper surface of the coupler 310 described below.

In addition, rear ends (connections) of the upper terminals 220 protrude rearwardly of the upper insulation layer 210 and then are bent downwards to be mounted on the upper surface of the PCB.

Here, the rear ends of the upper terminals 220 may be bent downwards to be mounted on the PCB after extending farther rearwards than the rear ends of the lower terminals 130.

The upper ground 230 is coupled to the upper surface of the upper insulation layer 210 to be connected to the middle plate 110 and is disposed between the front and rear ends of the upper terminals 220.

Here, the upper ground 230 may be formed to have a predetermined area using a conductive material and has an upper surface securely coupled to the upper surface of the upper insulation layer 210.

To this end, the upper ground 230 has a pair of second insertion ends 231 bent downwards from respective lateral ends thereof to be mated with the respective second insertion grooves 112.

The second insertion ends 231 are correspondingly inserted into the second insertion grooves 112 and may be disposed at the respective lateral ends of the upper ground 230 to be diagonal to each other.

Particularly, the upper ground 230 has a pair of rear carrier cutting portions 240 protruding from respective lateral ends thereof in the lateral direction, as shown in FIG. 7 to FIG. 11.

Protruding ends of the rear carrier cutting portions 240 are connected to a rear carrier 250 for conveyance of the receptacle connector to an assembly position.

Here, the rear carrier 250 is spaced in rear of the second assembly 200 and may have portions extending forward from respective lateral ends thereof to be perpendicularly connected to the rear carrier cutting portions 240.

In addition, the rear carrier 250 may have at least one vertical cut-out hole (not designated by reference numeral) for conveying the receptacle connecter to an assembly position using suitable equipment.

The upper insulation layer 210 has a pair of horizontal holes 212 vertically formed at respective lateral ends thereof to allow the second insertion ends 231 to be inserted into the second insertion grooves 112 therethrough.

Since the second insertion ends 231 are coupled to the second insertion grooves 112 through the horizontal holes 212, respectively, coupling force between the upper ground 230 and the upper insulation layer 210 can be further improved.

It should be understood that manufacture of the second assembly 200 is not necessarily preceded by manufacture of the first assembly 100 and the second assembly 200 may be manufactured before the first assembly 100, as needed.

In the housing formation step (S200), the second assembly 200 is partially superimposed onto the first assembly 100 and then the housing 300 is coupled to exteriors of the first assembly 100 and second assembly 200 by insert molding.

Referring to FIG. 12, the upper surface of the first assembly 100 is coupled to the lower surface of the second assembly 200 such that the upper ground 230 is mated with the middle plate 110.

At this point, the upper surface of the lower insulation layer 120 is pressed against the lower surface of the middle plate 110 and the lower surface of the upper insulation layer 210 is pressed against the upper surface of the middle plate 110.

Then, the pair of first insertion ends 141 bent upwardly of the lower ground 140 is inserted into and electrically connected to the first insertion grooves 111 formed at the respective lateral ends of the middle plate 110, respectively.

At the same time, the pair of second insertion ends 231 bent downwardly of the upper ground 230 is inserted into and electrically connected to the second insertion grooves 112 formed at lateral ends of the middle plate 110, respectively.

Since the second insertion ends 231 of the upper ground 230 are coupled to the respective second insertion grooves 112 at the same time as the first insertion ends 141 of the lower ground 140 are coupled to the respective first insertion grooves 111, assembly between the first assembly 100 and the second assembly 200 is completed.

Then, the housing 300 is insert-molded onto the first assembly 100 and the second assembly 200 to partially surround the first assembly 100 and the second assembly 200.

The contact surfaces of the lower terminals 130 and the upper terminals 220 and the front region of the middle plate 110 are exposed through the front coupler 310 of the housing 300 and the rear ends of the lower terminals 130 and the upper terminals 220 and the rear region of the middle plate 110 are exposed through a rear lower surface of the housing 30.

The housing 300 is formed of a conductive material and is insert-molded to surround the lower insulation layer 120 and the upper insulation layer 210. In addition, the housing 300 includes the coupler 310 protruding forward from a front end thereof to be coupled to a plug connector (not shown).

The coupler 310 is configured to be coupled to the plug connector (not shown) for connection to an electronic device and covers upper and lower surfaces of the front region of the middle plate 110.

Here, the front region (that is, a side surface) of the middle plate 110 is exposed in a lateral direction of the coupler 310 and the fastening protrusions 113 formed at the respective lateral ends of the middle plate 110 protrude laterally.

In addition, the front contact surfaces of the lower terminals 130 are exposed downwards through a lower surface of the coupler 310 and the front contact surfaces of the upper terminals 220 are exposed upwards through an upper surface of the coupler 310.

After the housing formation step (S200), the method according to the embodiment may further include a carrier cutting step (S300) in which the front carrier cutting portions 150 and the rear carrier cutting portions 240 are cut to separate the front carrier 160 and the rear carrier 250 from the receptacle connector.

That is, the front carrier 160 and the rear carrier 250 used in formation of the housing 300 are removed after formation of the housing 330.

In the carrier cutting step (S300), since the rear carrier cutting portions 240 protruding through the passage holes 340 are exposed outside, a portion of the rear carrier 250 connected to each of the rear carrier cutting portions 240 can be easily cut.

Next, a receptacle connector according to one embodiment of the present disclosure will be described with reference to FIG. 2 to FIG. 15. A receptacle connector according to one embodiment of the present disclosure includes a first assembly 100, a second assembly 200, and a housing 300.

Referring to FIG. 2 to FIG. 5, the first assembly 100 may include a middle plate 110, a lower insulation layer 120, a plurality of lower terminals 130, and a lower ground 140.

The middle plate 110 may be manufactured to have a predetermined area using a conductive material and is securely coupled at a rear end thereof to an upper surface of a PCB.

Here, the middle plate 110 is divided into a rear region coupled to the PCB and a front region located inside a coupler 310 described below.

In addition, the middle plate 110 has a pair of fastening protrusions 113 protruding from respective lateral ends of the front region and a pair of connection ends 130 bent downwards from respective lateral ends of the rear region.

Each of the connection ends 130 is inserted into and securely coupled to the upper surface of the PCB and has an extended tip protruding downward through a lower surface of the housing 300 described below to be coupled to the PCB.

In addition, the middle plate 110 has a pair of first insertion grooves 111 formed on respective lateral ends of the rear region to correspondingly receive first insertion ends 141 described below to achieve electrical connection therebetween.

Specifically, the first insertion grooves 111 correspondingly receive the first insertion ends 141 of the lower ground 140 described below and may be disposed at the respective lateral ends of the middle plate 110 to be diagonal to each other.

Further, the middle plate 110 has a pair of second insertion grooves 112 formed on respective lateral ends of the rear region to correspondingly receive second insertion ends 231 described below to achieve electrical connection therebetween.

Specifically, the second insertion grooves 112 correspondingly receive the second insertion ends 141 of an upper ground 230 described below and may be disposed at the respective lateral ends of the middle plate 110 to be diagonal to each other.

The lower insulation layer 120 is coupled to the lower surface of the middle plate 110 and has an installation hole 121 formed in a transverse direction thereof.

Here, the installation hole 121 of the lower insulation layer 120 may include plural (for example, 12) installation holes 121 arranged in a lateral direction of the lower insulation layer 120, and has a front portion open downward.

The middle plate 110 may have a plurality of vertical cut-out holes, and the lower insulation layer 120 may protrude upward through the cut-out holes of the middle plate 110 to be caught on the upper surface of the middle plate 110.

The lower terminals 130 pass through and are coupled to the respective installation holes 121 of the lower insulation layer 120 in the transverse direction, and contact surfaces of the lower terminals 130 are exposed downwardly of the respective installation holes 121.

In addition, rear ends of the lower terminals 130 protrude rearwardly of the respective installation holes 121 and then are bent downwards to be mounted on the upper surface of the PCB.

The lower ground 140 is coupled to the lower surface of the lower insulation layer 120 to be mated with the middle plate 110 and is disposed between the front and rear ends of the lower terminals 130.

The lower ground 140 may be manufactured to have a predetermined area using a conductive material, and has an upper surface securely coupled to the lower surface of the lower insulation layer 120.

To this end, the lower ground 140 has a pair of first insertion ends 141 bent upwards from respective lateral ends thereof to be mated with the respective first insertion grooves 111.

The first insertion ends 141 are correspondingly inserted into and coupled to the first insertion grooves 111 and may be disposed at the respective lateral ends of the lower ground 140 to be diagonal to each other.

Particularly, the middle plate 110 has a pair of front carrier cutting portions 150 protruding from respective lateral ends thereof in a lateral direction thereof, as shown in FIG. 2 to FIG. 5.

A protruding tip of each of the front carrier cutting portions 150 is connected to a front carrier 160 for conveyance of the receptacle connector to an assembly position.

Here, the front carrier 160 is spaced in front of the first assembly 100 and has portions extending rearwards from respective lateral ends thereof to be perpendicularly connected to the respective front carrier cutting portions 150.

Referring to FIG. 7 to FIG. 11, the second assembly 200 includes an upper insulation layer 210, a plurality of upper terminals 220, and an upper ground 230.

The upper insulation layer 210 is coupled to the upper surface of the middle plate 110 and has an installation hole 211 formed therethrough in the transverse direction.

Here, the installation hole 211 of the upper insulation layer 210 may include plural (for example, 12) installation holes arranged in a lateral direction of the upper insulation layer 210, and has a front portion open upward.

The upper terminals 220 pass through and are coupled to the respective installation holes 211 of the upper insulation layer 210 in the transverse direction, and contact surfaces of the upper terminals 220 are exposed upwardly of the installation holes 211.

Rear ends of the upper terminals 220 protrude rearwardly of the respective installation holes 211 and then are bent downwards to be mounted on the upper surface of the PCB (not shown).

Here, the rear ends of the upper terminals 220 may be bent downwards to be mounted on the PCB after extending farther rearwards than the rear ends of the lower terminals 130.

The upper ground 230 is coupled to the upper surface of the upper insulation layer 210 to be mated with the middle plate 110 and is disposed between the front and rear ends of the upper terminals 220.

Here, the upper ground 230 may be manufactured to have a predetermined area using a conductive material, and has an upper surface securely coupled to the upper surface of the upper insulation layer 210.

To this end, the upper ground 230 has a pair of second insertion ends 231 bent downwards from respective lateral ends thereof to be mated with the respective second insertion grooves 112.

The second insertion ends 231 are correspondingly inserted into and coupled to the second insertion grooves 112 and may be disposed at the lateral ends of the upper ground 230 to be diagonal to each other.

Particularly, the upper ground 230 has a pair of rear carrier cutting portions 240 protruding from respective lateral ends thereof in the lateral direction, as shown in FIG. 7 to FIG. 11.

Protruding tips of the rear carrier cutting portions 240 are connected to a rear carrier 250 for conveyance of the receptacle connector to an assembly position.

Here, the rear carrier 250 is spaced in rear of the second assembly 200 and may have portions extending forward from respective lateral ends thereof to be perpendicularly connected to the respective rear carrier cutting portions 240.

The upper insulation layer 210 has horizontal holes 212 vertically formed at respective lateral ends thereof to allow the second insertion ends 231 to be inserted into the second insertion grooves 112 therethrough.

That is, since the second insertion ends 231 are coupled to the second insertion grooves 112 through the horizontal holes 212, respectively, coupling force between the upper ground 230 and the upper insulation layer 210 can be further improved.

The housing 300 is insert-molded onto the first assembly 100 and the second assembly 200 and is formed of a conductive material.

Specifically, the housing 300 is insert-molded to cover the lower insulation layer 120 and the upper insulation layer 210 and includes a coupler 310 protruding forward from the front end thereof to be coupled to a plug connector (not shown).

The coupler 310 is coupled to the plug connector for connection to an electronic device and covers upper and lower portions of the front region of the middle plate 110.

Here, the front region (that is, a side surface) of the middle plate 110 is exposed in a lateral direction of the coupler 310 and the fastening protrusions 113 formed at the respective lateral ends of the middle plate 110 protrude laterally.

Front contact surfaces of the lower terminals 130 are exposed downward through a lower surface of the coupler 310 and front contact surfaces of the upper terminals 220 are exposed upward through an upper surface of the coupler 310.

In addition, the housing 300 has front vertical holes 350 formed at a lower portion thereof to allow respective rear ends of the lower terminals 130 to protrude downward therethrough.

Further, the housing 300 has rear vertical holes 360 formed behind the front vertical hole 350 to allow respective rear ends of the upper terminals 220 to protrude downward therethrough.

That is, the rear ends of the lower terminals 130 protruding through the front vertical holes 350 and the rear ends of the upper terminals 220 protruding through the rear vertical holes 360 are mounted on the PCB through the lower side of the housing 300.

Moreover, the housing 300 has a lower insertion groove 320 formed on a lower surface thereof and corresponding in position to the lower ground 140 and an upper insertion groove 330 formed on an upper surface thereof and corresponding in position to the upper ground 230.

In addition, the housing 300 has a pair of passage holes 340 formed through respective lateral ends thereof in the lateral direction thereof to allow the rear carrier cutting portions 240 to protrude therethrough.

That is, since the rear carrier cutting portions 240 protruding through the respective passage holes 340 are exposed outside, a portion of the rear carrier 250 connected to each of the rear carrier cutting portions 240 can be easily cut.

According to the embodiment of the present disclosure, the first assembly 100 having the lower ground 140 and the second assembly 200 having the upper ground 230 are insert-molded at the same time to form the housing 300, whereby the lower ground 140 and the upper ground 230 can be integrally formed with the housing 300 by insert molding, thereby eliminating a need for press-fitting of the lower ground 140 and the upper ground 230.

In addition, according to the embodiment of the present disclosure, since the first assembly 100 and the second assembly 200 are insert-molded at the same time to form the housing, whereby formation of the housing can be achieved without movement of the first assembly and the second assembly, thereby securing product reliability.

Further, according to the embodiment of the present disclosure, bidirectional coupling of the plug connector to the receptacle connecter is possible, thereby enabling quick coupling of the plug connector regardless of the direction of the plug connector.

Moreover, according to the embodiment of the present disclosure, since the front carrier cutting portions and the rear carrier cutting portions are exposed in the lateral direction of the housing and then connected to the front carrier and the rear carrier, respectively, easy separation of the front carrier and the rear carrier from the receptacle connector can be achieved during a subsequent carrier separation process.

Furthermore, according to the embodiment of the present disclosure, since the lower ground 140 and the upper ground 230 are mated with respective side portions of the middle plate 110, assembly between the lower ground 140 and the upper ground 230 can be easily achieved while allowing robust assembly between the lower ground 140, the upper ground 230, and the middle plate 110.

Although a method of manufacturing a receptacle connector according to the present disclosure and a receptacle connector manufactured using the same have been described with reference to some embodiments, it should be understood that the embodiments described herein may be embodied in a variety of other forms without departing from the spirit and scope of the present disclosure.

Therefore, the scope of the present disclosure is not intended to be limited to the foregoing embodiments and should be defined by the appended claims and equivalents thereto.

That is, it should be understood that the foregoing embodiments are given by way of illustration only and the present disclosure is not limited thereto. In addition, it should be understood that various modifications, variations, and alterations can be made by those skilled in the art without departing from the spirit and scope of the present disclosure. Therefore, the scope of the present disclosure should be interpreted according to the following appended claims and equivalents thereto.

### LIST OF REFERENCE NUMERALS

| | |
|---|---|
| 100: First assembly | 110: Middle plate |
| 111: First insertion groove | 112: Second insertion groove |
| 113: Fastening protrusion | 114: Connection end |
| 120: Lower insulation layer | 121: Installation hole |
| 130: Lower terminal | 140: Lower ground |
| 141: First insertion end | 150: Front carrier cutting portion |
| 160: Front carrier | 200: Second assembly |
| 210: Upper insulation layer | 211: Installation hole |
| 212: Through-hole | 220: Upper terminal |
| 230: Upper ground | 231: Second insertion end |
| 240: Rear carrier cutting portion | 250: Rear carrier |
| 300: Housing | 310: Coupler |
| 320: Lower insertion groove | 330: Upper insertion groove |
| 340: Passage hole | |

What is claimed is:

1. A method of manufacturing a receptacle connector, comprising:
an assembly formation step in which a first assembly is formed by superimposing a lower terminal, a middle plate, and a lower ground onto one another and integrating a lower insulation layer with exteriors of the lower terminal, middle plate, and lower ground by insert molding and a second assembly is formed by superimposing an upper terminal and an upper ground onto one another and integrating an upper insulation layer with exteriors of the upper terminal and upper ground by insert molding; and
a housing formation step in which the second assembly is partially superimposed onto the first assembly and a housing is insert-molded to partially surround the first assembly and the second assembly such that the lower terminal, the upper terminal, and the middle plate are exposed through a front coupler of the housing and through a rear lower surface of the housing.

2. The method according to claim 1, wherein, in the assembly formation step, a pair of front carrier cutting portions protrudes from respective lateral ends of the middle plate and a front carrier is connected to the pair of front carrier cutting portions, and, in the housing formation step, a pair of rear carrier cutting portions protrudes from respective lateral ends of the upper ground in a lateral direction of the housing and a rear carrier is connected to the pair of rear carrier cutting portions.

3. The method according to claim 2, further comprising: after the housing formation step,
a carrier cutting step in which the front carrier and the rear carrier are separated from the receptacle connecter by cutting the front carrier cutting portions and the rear carrier cutting portions.

4. The method according to claim 2, wherein, in the housing formation step, a pair of passage holes is formed at respective lateral ends of the housing to allow the pair of rear carrier cutting portions to protrude therethrough.

5. The method according to claim 1, wherein, in the housing formation step, a lower insertion groove is formed on a lower surface of the housing to correspond in position to the lower ground and an upper insertion groove is formed on an upper surface of the housing to correspond in position to the upper ground.

6. The method according to claim 1, wherein, in the assembly formation step, a pair of first insertion ends bent upwards from respective lateral ends of the lower ground is formed; a pair of first insertion grooves is formed at respective lateral ends of the middle plate to correspondingly receive the first insertion ends; a pair of second insertion ends bent downwards from respective lateral ends of the upper ground is formed; and a pair of second insertion grooves is formed at respective lateral ends of the middle plate to correspondingly receive the second insertion ends.

7. The method according to claim 1, wherein, in the housing formation step, a connection end bent downwards from a rear end of the middle plate protrudes downwardly of the housing.

8. A receptacle connector comprising:
a first assembly comprising a middle plate, a lower insulation layer coupled to a lower surface of the middle plate, a plurality of lower terminals passing through and coupled to the lower insulation layer in a transverse direction, and a lower ground coupled to a lower surface of the lower insulation layer to be mated with the middle plate;
a second assembly comprising an upper insulation layer coupled to an upper surface of the middle plate, a plurality of upper terminals passing through and coupled to the middle plate in the transverse direction, and an upper ground coupled to an upper surface of the upper insulation layer to be mated with the middle plate; and
a housing partially surrounding the first assembly and the second assembly and comprising a front coupler exposing front sections of the lower terminals, upper terminals, and middle plate therethrough and a rear lower surface exposing rear sections of the lower terminals, upper terminals, and middle plate therethrough.

9. The receptacle connector according to claim 8, further comprising:
a pair of front carrier cutting portions protruding from respective lateral ends of the middle plate in a lateral direction of the coupler to be connected to a front carrier; and
a pair of rear carrier cutting portions protruding from respective lateral ends of the upper ground in a lateral direction of the housing to be connected to a rear carrier.

10. The receptacle connector according to claim 9, wherein the housing has a pair of passage holes formed at respective lateral ends thereof to allow the rear carrier cutting portions to protrude therethrough.

11. The receptacle connector according to claim 8, wherein the insulating housing has:
a lower insertion groove formed on a lower surface thereof to correspond in position to the lower ground; and
an upper insertion groove formed on an upper surface thereof to correspond in position to the upper ground.

12. The receptacle connector according to claim 8, wherein the lower ground has a pair of first insertion ends bent upwards from respective lateral ends thereof,
the upper ground has a pair of second insertion ends bent downwards from respective lateral ends thereof, and
the middle plate has a pair of first insertion grooves receiving the respective first insertion ends and a pair of second insertion grooves receiving the respective second insertion ends,
the pair of first insertion grooves and the pair of second insertion grooves being arranged at respective lateral ends of the middle plate in the transverse direction.

13. The receptacle connector according to claim 12, wherein the upper insulation layer has horizontal holes vertically formed at respective lateral ends thereof to allow the second insertion ends to be inserted into the second insertion grooves therethrough.

14. The receptacle connector according to claim 1, wherein each of the upper terminals has a front end exposed through an upper surface of the coupler and a rear end protruding downwardly of the housing,
each of the lower terminals has a front end exposed through a lower surface of the coupler and a rear end protruding downwardly of the housing, and
the middle plate has a front end exposed in front of and at both lateral sides of the coupler.

15. The receptacle connector according to claim 14, wherein the middle plate has connection ends bent downwards from respective rear lateral ends thereof to protrude downwardly of the housing.
